(19) United States
(12) Patent Application Publication
(10) Pub. No.: US 2012/0291873 A1
(43) Pub. Date: Nov. 22, 2012

(54) Hydraulic circuit

(76) Inventors: Steven Potter, Bedford, MA (US); Chris Richburg, Somerville, MA (US)

(21) Appl. No.: 13/068,717

(22) Filed: May 18, 2011

(51) Int. Cl. F16K 7/00

(52) U.S. Cl. 137/12; 137/861

(57) ABSTRACT

A hydraulic circuit and method includes a valve subsystem between a high pressure source, a medium pressure source, a low pressure return, and an actuator. The valve subsystem is configured and controllable to drive the actuator using the high pressure hydraulic fluid or the medium pressure hydraulic fluid and also to direct low pressure hydraulic fluid exiting the actuator to the low pressure return. A controller is responsive to high pressure criteria and medium pressure criteria associated with the actuator and is configured to operate the valve subsystem to present high pressure hydraulic fluid to the actuator in response to high pressure criteria and to present medium pressure hydraulic fluid to the actuator in response to medium pressure criteria.

### FIELD OF THE INVENTION

The subject invention relates to hydraulic circuits and actuators.

### BACKGROUND OF THE INVENTION

Hydraulic systems including actuators are well known. Typically, a pump supplies hydraulic fluid under pressure to an actuator via a valve. In U.S. Pat. No. 5,289,680 incorporated herein by this reference, actuators can be alternatively connected to a large or a small displacement pump via a selector valve to provide different flow rates to the actuators. U.S. Pat. No. 6,067,946, also incorporated herein by this reference, discloses a poppet valve actuatable using high pressure hydraulic fluid (500-3,000 psig) and then low pressure hydraulic fluid (25-100 psig). U.S. Pat. No. 7,600,715 discloses redundant hydraulic systems; U.S. Pat. No. 5,615,553 discloses a hydraulic circuit in which one pump supplements another; and U.S. Pat. No. 7,401,465 discloses two actuators, one connected to an engine driven high pressure positive displacement pump and another connected to an engine driven low pressure positive displacement pump. U.S. Pat. No. 6,305,163 discloses a walking robot and a load sensing hydraulic system. Published U.S. Patent Application No. US 2010/0090638 also discloses a walking robot with unique actuators. All of these references are also incorporated herein by this reference.

Thus, the art includes a variety of hydraulic systems.

In some environments, the power available for the pump(s) in the hydraulic system is limited. In the case of walking robots, for example, a robot must transport its own internal combustion engine and fuel to provide power for driving the pumps. The larger the engine (and its fuel supply), the less cargo that can be transported by the robot.

In such a robot, the actuators intermittently require high pressure actuation but much of the time the forces are low and the actuators require less pressure.

### SUMMARY OF THE INVENTION

It is therefore an aspect of the invention, in one preferred embodiment, to provide a new hydraulic circuit in which an actuator is driven using high pressure hydraulic fluid or medium pressure hydraulic fluid depending on various criteria in order to reduce the power requirements of the system employing the hydraulic circuit. In one preferred embodiment, a valve subsystem is configured and controllable to actuate the actuator in various modes including high and medium pressure extension and retraction, regeneration, braking, coasting, and the like.

The invention features, in one aspect, a hydraulic circuit comprising a high pressure source of high pressure hydraulic fluid, a medium pressure source of medium pressure hydraulic fluid, and a low pressure return for low pressure return hydraulic fluid. A valve subsystem is between the high pressure source, the medium pressure source, the low pressure return, and an actuator. The valve subsystem is controllable to drive the actuator using the high pressure hydraulic fluid or the medium pressure hydraulic fluid switching between the two and also to direct low pressure hydraulic fluid exiting the actuator to the low pressure return. A controller is responsive to high pressure criteria and medium pressure criteria associated with the actuator and is configured to switch the valve subsystem to present high pressure hydraulic fluid to the actuator in response to high pressure criteria and to present medium pressure hydraulic fluid to the actuator in response to medium pressure criteria.

Typically, the actuator is a double acting actuator. The high and medium pressure criteria are typically a function of the force and/or speed to be produced by the actuator. In some embodiments, the valve subsystem includes a pressure control valve configured to select which of the high pressure hydraulic fluid and the medium pressure hydraulic fluid is delivered to the actuator. The valve subsystem may further include a direction control valve configured to select the direction of action of the actuator. In one version, the pressure control valve is switchable to direct high or medium pressure hydraulic fluid to the direction control valve which may be a four-way direction control valve.

The pressure control valve in some embodiments may include means for controlling the flow rate of the hydraulic fluid delivered to the actuator. In one example, the pressure control valve includes a supply side including high pressure hydraulic fluid and medium pressure hydraulic fluid ports and a return side including medium pressure hydraulic fluid and low pressure return hydraulic fluid ports.

The valve subsystem may be configured to valve low pressure return hydraulic fluid to the actuator and/or to control the flow rate of hydraulic fluid delivered to the actuator. Also, the valve subsystem may be configured to selectively valve high pressure hydraulic fluid produced by the actuator to the high pressure source and to selectively valve medium pressure hydraulic fluid produced by the actuator to the medium pressure hydraulic fluid source.

In some embodiments, a spool valve is configured to both select which of the high pressure hydraulic fluid and the medium pressure hydraulic fluid is delivered to the actuator and to select the direction of action of the actuator. In some designs, the valve subsystem includes a valve with a spool and ports arranged such that movement of the spool in one direction progresses from providing medium pressure fluid to the actuator and then providing high pressure fluid to the actuator. In one example, the spool valve has a return side and a supply side configured such that movement of the spool in one direction provides progressively decreasing pressure fluid on the return side and then provides progressively increasing pressure fluid on the supply side.

For a double acting actuator, the valve subsystem is preferably configured to actuate the actuator in a first direction and a second direction and in four or more modes including, for example, regeneration of high pressure hydraulic fluid during actuation of the actuator in both directions, regeneration of medium pressure hydraulic fluid during actuation in both directions, braking of the actuator during actuation in both directions, medium pressure actuation of the actuator both directions, and high pressure actuation of the actuator in both directions. During a change in modes, it is preferred that flow to the actuator is not interrupted.

Also featured is a method of actuating an actuator comprising producing high pressure hydraulic fluid, producing medium pressure hydraulic fluid, and valving low pressure hydraulic fluid. High and medium pressure criteria are established for the actuator. Then, in response to high pressure criteria, the actuator is driven using high pressure hydraulic fluid and, in response to medium pressure criteria, the actuator is driven using medium pressure fluid. The method may include selecting which of the high pressure hydraulic fluid and the medium pressure hydraulic fluid is delivered to the actuator and also selecting the direction of the actuator. The flow rate of the hydraulic fluid delivered to the actuator may be controlled. Low pressure return hydraulic fluid can be presented to the actuator. High and medium pressure hydraulic fluid produced by the actuator can be valved.

For an actuator with first and second chambers, the method may include selectively valving high pressure hydraulic fluid to each chamber, medium pressure hydraulic fluid to each chamber, and low pressure hydraulic fluid from each chamber and also, in one preferred embodiment, selectively valving high pressure hydraulic fluid from each chamber, medium pressure hydraulic fluid from each chamber, and low pressure hydraulic fluid to each chamber.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional front view showing an example of a walking robot in accordance with the invention;

FIG. 2 is a schematic side view showing an example of a robot leg and an actuator for the robot of FIG. 1;

FIG. 3 is a schematic block diagram showing several of the primary components associated with an example of a new hydraulic circuit in accordance with the invention;

FIG. 4 is a schematic hydraulic circuit diagram showing one example of a valve subsystem useful for a double acting actuator;

FIGS. 5A-5F are schematic views of the valve subsystem shown in FIG. 4 depicting the various modes available including medium pressure extension, high pressure extension, medium pressure retraction, high pressure retraction, high pressure extension regeneration, and high pressure retraction regeneration, respectively;

FIG. 6 is a schematic hydraulic circuit diagram showing another example of a valve subsystem in accordance with the invention;

FIG. 7A-7J are schematic diagrams showing the different positions of the valves of the valve subsystem shown in FIG. 6 in order to actuate the actuator in a variety of modes including medium pressure extension, high pressure extension, extension regeneration to the high pressure source, extension regeneration to the medium pressure source, extension braking, medium pressure retraction, high pressure retraction, retraction regeneration to the high pressure source, retraction regeneration to the medium pressure source, and retraction braking, respectively;

FIG. 8 is a schematic hydraulic circuit diagram showing another example of a valve subsystem for a double acting actuator;

FIGS. 9A-9J are schematic views showing different positions of the valve shown in FIG. 8 in order to actuate the actuator in a variety of modes including medium pressure extension, high pressure extension, extension regeneration to the high pressure source, extension regeneration to the medium pressure source, extension braking, medium pressure retraction, high pressure retraction, retraction braking, retraction regeneration to the medium pressure source, and retraction regeneration to the high pressure source, respectively;

FIG. 10 is a schematic view showing a minor variation on the embodiment shown in FIGS. 8, 9A-9J;

FIG. 11 is a chart depicting ten possible modes of operation in accordance with several examples of the subject invention;

FIG. 12 is a schematic view of a portion of a hydraulic circuit showing a multiple pressure system in accordance with another example of the invention;

FIGS. 13A-13E are schematic views showing an example of a multi-pressure spool valve in accordance with an example of the invention;

FIGS. 14A-14B are schematic views showing an example of another spool valve in accordance with an example of the subject invention; and

FIGS. 15A-15E are schematic views showing a spool valve in accordance with still another example of the subject invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

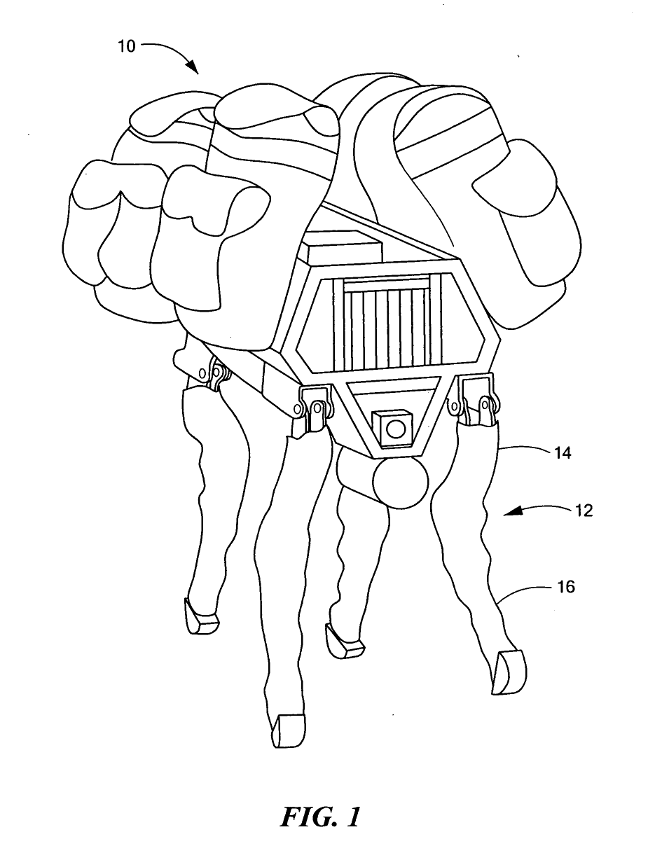

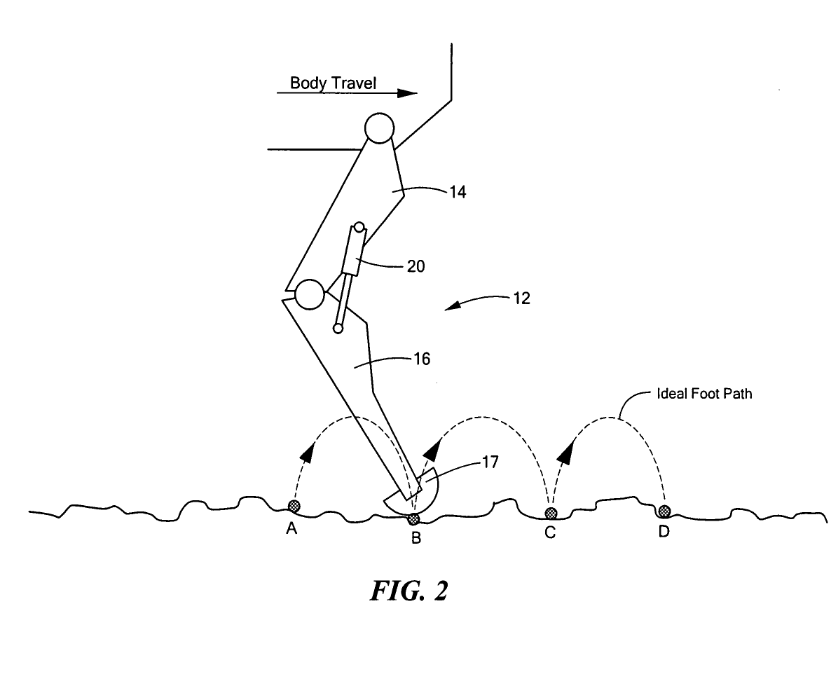

The subject invention can be employed with a variety of different robotic, bionic, and other systems. As one example, FIG. 1 shows a legged robot 10 called “Big Dog” under development by the applicant hereof (Boston Dynamics, Inc., Waltham, Mass.). Robot leg 12 includes thigh member 14 and shin member 16. FIG. 2 shows, in a highly schematic fashion, piston-cylinder type double action actuator assembly 20 between thigh member 14 and shin member 16. It is understood that various mechanical linkages and the like associated with piston-cylinder assembly 20 are not shown. A walking robot in accordance with the subject invention typically includes a number of such double acting actuators. Prototype versions of robot 10, FIG. 1 are able to walk, run, climb, walk across rubble, and carry a 3301b load. But, it may be desirable to increase the load carrying capacity of robot 10 meaning leg 12, FIG. 2 will experience greater forces. Increasing the load carrying capacity, in turn, results in an increase in the size and capability of the hydraulic power plant. That result, however, undesirably lowers the payload capacity of the robot. It would also be desirable to reduce the size and weight of the existing power plant.

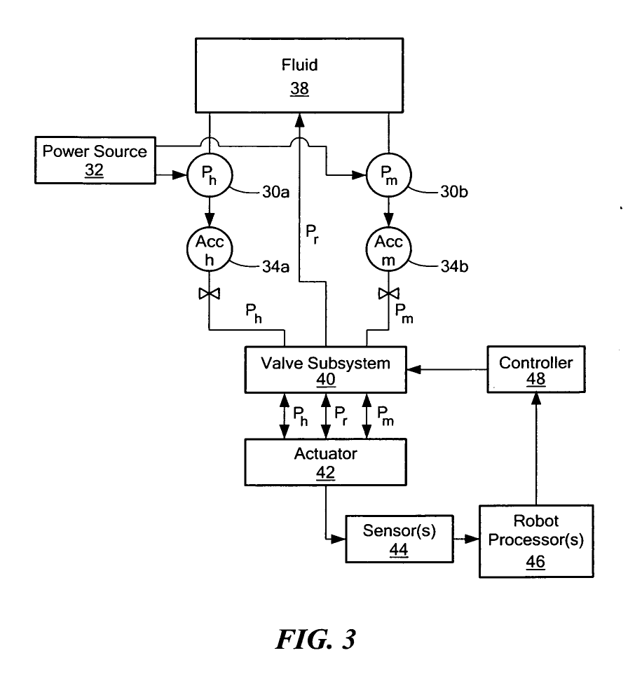

There are times when actuator 20 provides high force operations such as when foot 17 is engaged with the ground, and leg 12 bears weight. Another example is when a given leg is supporting a greater proportion of the total load due to a specific maneuver or behavior. Jumping is but one example of high force operation. In such modes, high pressure hydraulic fluid may be required. In many other instances, only medium force operation is required such as when thigh member 14 lifts shin member 16 to swing the leg forward. Here, perhaps only medium pressure hydraulic fluid is required to drive the actuator. Note, however, that high pressure actuation does not necessarily always correlate to high force operations. FIG. 3 shows a high pressure source of high pressure hydraulic fluid Pₕ (e.g., 3,000 psig), for example, via variable displacement pump 30a (driven by power source 32, e.g., an internal combustion engine or electric motor carried by the robot) and accumulator 34a. A medium pressure source of medium pressure hydraulic fluid Pₘ (e.g., 1,000-1,500 psig), is produced, for example, by variable displacement pump 30b (also driven by engine 32) and accumulator 34b. A low pressure return for low pressure hydraulic fluid Pᵣ (e.g., 100 psig) to fluid storage 38 is also shown. Valve subsystem 40 is controllable to drive actuator 42 (preferably a double acting actuator such as the piston-cylinder arrangement shown in FIG. 2) using either high pressure fluid Pₕ or medium pressure fluid Pₘ and to direct low pressure fluid Pᵣ exiting the actuator to fluid source 38. In some embodiments, Valve subsystem 40 may also supply low pressure flow to one or more actuators, thus conserving energy. In other variations, valve subsystem 40 directs flow from one or more actuators to the medium pressure accumulator 34b or high pressure accumulator 34a which regenerates some of the mechanical work done on the actuator(s) and stores the energy for later use. In many embodiments, however, the valve subsystem 40 is controllable to “drive” actuator 42 using either the high pressure fluid source Pₕ or the medium pressure fluid source Pₘ (i.e. consuming high or medium pressure flow). Typically, valve system 40 will also throttle the flow as needed to provide the desired actuator force or speed.

Signals from sensor(s) 44 may be used to establish high pressure criteria and medium pressure criteria for actuator 42. One sensor subsystem typically includes a load sensor and position sensor measuring the force and displacement of the actuator. Many other sensor arrangements are possible, for instance, measuring the actuator chamber pressures, or measuring the force at foot 17 and backing out the actuator force based on the kinematics and dynamics of the robot's links.

Controller 48 (e.g., a controller, processor, or other electronic circuit) is responsive to sensor subsystem 44 and also (typically) robot behavioral processor(s) 46 and is configured (e.g., programmed) to electronically operate valve subsystem 40 depending on whether actuator 42 is to be actuated using the high pressure source or the medium pressure source, or in some other mode depending on various criteria established by robot processing subsystem 46, typically in response to the output of sensor subsystem 44. Note that control circuit 48 need not be a separate chip or component. Instead, the logic of controller 48 could be integrated within the control system of the robot and/or within the robot processing subsystem 46. There are many ways the controller can choose when to switch between medium and high pressure. The inputs include the desired force and speed, actual force and speed, and predicted force and speed. Some subset of these may be used to make the decision. In general, the controller is programmed to try and maintain enough “pressure margin” so that the actuator does not run out of force or speed capability.

In one example, when sensor subsystem 44 signals controller 48 that actuator 42 requires only medium pressure, controller 48 then controls valve subsystem 40 to draw from the medium pressure source to supply hydraulic fluid to actuator 42. In another example, sensor subsystem 44 dictates that actuator 42 requires high pressure hydraulic fluid actuation and controller 48 then controls valve subsystem 40 to use the high pressure source to supply hydraulic fluid to actuator 42. The high pressure criteria and the medium pressure criteria associated with the actuator may vary depending on the design of the system and may be a function of the output of sensor subsystem 44 and/or robot behavioral processors 26.

Controller 48, in response to the high pressure criteria and medium pressure criteria, controls valve subsystem 40 accordingly. One way to control hydraulic valves is to use a two stage system where an electrically controllable valve controls a “pilot” pressure which moves a spool valve. Another method is to drive the moving part of the valve (e.g. a spool) directly with an electric actuator. In one example, the piston of actuator 42 can be extended using high pressure fluid (Pₕ) in response to high pressure criteria and then retracted using medium pressure fluid (Pₘ) in response to medium pressure criteria. With many actuators in a typical system, the power requirements of the system are thus lowered since high pressure hydraulic fluid is not always utilized. In examples of the invention, the power requirements are lowered by 50% or more.

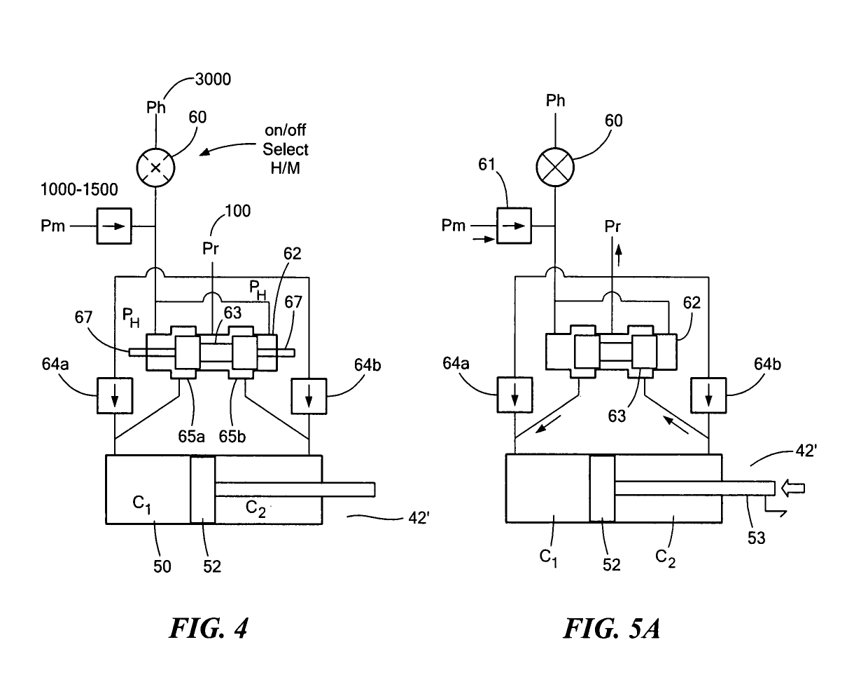

FIG. 4 shows but one example of a double acting actuator 42′ with cylinder 50 and piston 52 defining chambers C₁ and C₂. The valve subsystem in this example includes pressure control valve 60 and direction control valve 62. In the position shown with pressure control valve 60 open, high pressure hydraulic fluid Pₕ is delivered to chamber C₁ and low pressure hydraulic fluid Pᵣ exits chamber C₂. Anti-cavitation check valves 64a and 64b are also provided as shown. By controlling direction control valve 62 and opening and closing pressure control valve 60 under the command of controller 48, FIG. 3, other modes are possible. This valve subsystem arrangement allows medium pressure extension of piston 52, high pressure extension of piston 52, medium pressure retraction of piston 52, high pressure retraction of piston 52, and high pressure fluid regeneration in either direction given a sufficiently large aiding load (i.e. a load that does work on the actuator). Pressure control valve 60 may be a 2-way valve and direction control valve 62 may be a 4-way valve. Anti-cavitation check valves 64a and 64b allow for higher speeds when the actuator 42′ is doing negative work. This design also allows for a transition between medium pressure hydraulic fluid and high pressure hydraulic fluid without interrupting flow (i.e., without dead-heading). Pressure control valve 60, in general, selects which of the high pressure hydraulic fluid and the medium pressure hydraulic fluid is delivered to the actuator. Direction control valve 62 is configured to select which of chambers C₁ and C₂ communicates with the low pressure return Pᵣ. Typically, the actuator will tend to move in the direction that pushes fluid out to the low pressure return, however, under a large aiding load, the actuator 42′ can draw from the low pressure return and push high pressure fluid back (i.e. regenerate) to the high pressure source Pₕ. Direction control valve 62 uses spool 63 to open and close ports 65a and 65b. Spool 63 is typically moved right or left using an electric actuator or with fluid pressure to push or pull on spool extensions 67 as is well known in the art of servo-valve design. In subsequent figures, for simplicity, the spool extensions 67 have been omitted, but it should be assumed that the spool position is controlled. Actuator speed is typically controlled by adjusting the position of spool 63 to partially open ports 65a and 65b.

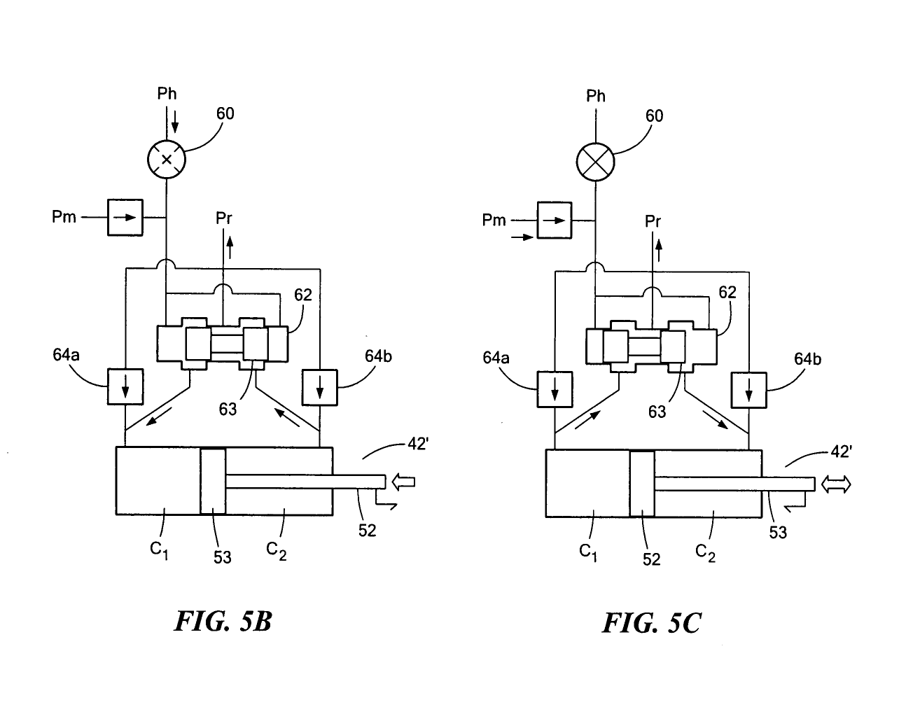

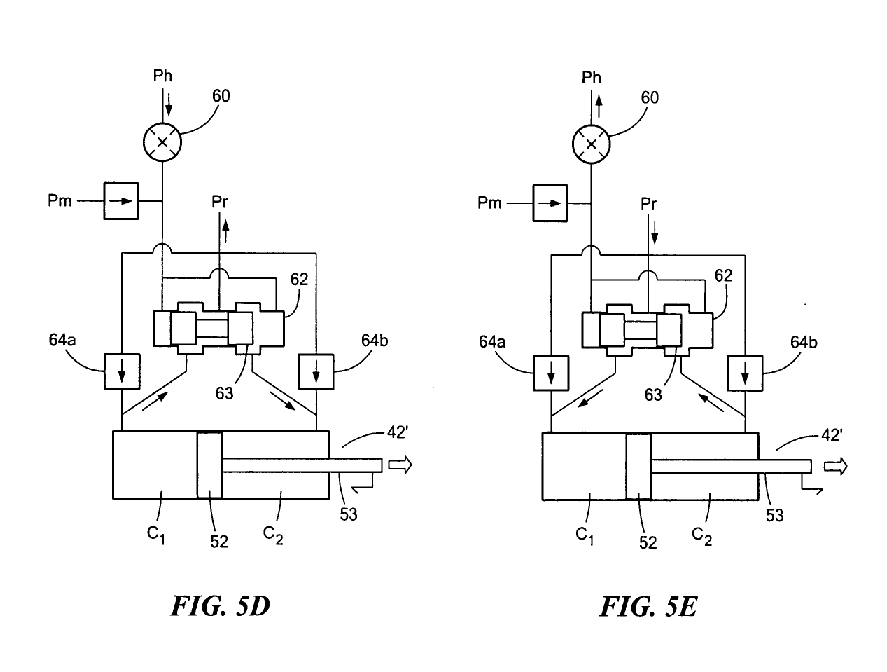

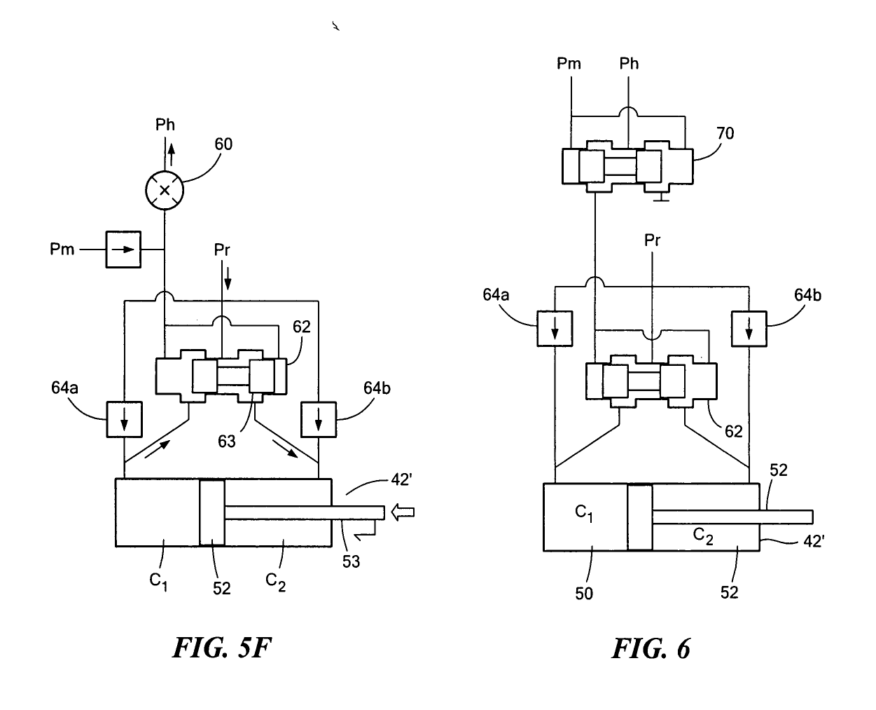

FIG. 5A shows double acting actuator 42′ in connection with direction control valve 62 and pressure control valve 60 in a medium pressure extension mode. Pressure control valve 60, FIG. 5A, is closed and medium pressure hydraulic fluid Pₘ from accumulator 34b, FIG. 3 enters direction control valve 62, FIG. 5A which is configured in this mode via the position of member 63 to valve medium pressure hydraulic fluid into chamber C₁ to drive piston 52 to the right, thus extending piston rod 53. Fluid exiting chamber C₂ is directed by direction control valve 62 to the low pressure (Pr) fluid source 38, FIG. 3. When pressure control valve 60 opens, the high pressure fluid closes check valve 61 to encourage an uninterrupted flow of fluid to the actuator.

FIG. 5B shows pressure control valve 60 open allowing high pressure hydraulic fluid Pₕ to be directed to chamber C₁. Pₕ in chamber C₁ causes high force extension of the piston 52. Hydraulic fluid exiting chamber C₂ is directed by direction control valve 62 to the low pressure (Pᵣ) fluid source 38, FIG. 3. This mode is called high pressure extension mode.

Depicted in FIG. 5C is a medium pressure retraction mode in which valve 60 is closed and thus medium pressure hydraulic fluid Pₘ enters direction control valve 62 and is directed to chamber C₂, causing the piston 52 to retract under a medium force. Hydraulic fluid exiting chamber C₂ is directed by direction control valve 62 to the low pressure (Pᵣ) fluid source 38, FIG. 3.

In a high pressure retraction mode, FIG. 5D, valve 60 is open and high pressure hydraulic fluid Pₕ enters direction control valve 62 and is directed to chamber C₂, causing the piston 52 to retract with a higher force. Hydraulic fluid exiting chamber C₂ is directed by direction control valve 62 to the low pressure (Pᵣ) fluid source 38, FIG. 3.

FIG. 5E depicts a high pressure extension regeneration mode when a high force load pulls or extends piston rod 53. Low pressure hydraulic fluid Pᵣ is directed by valve 62 to chamber C₁. Low pressure hydraulic fluid Pᵣ may also bypass valve 62 and enter chamber C₁ by passing through anti-cavitation check valve 64a. This avoids cavitation that might otherwise result if the actuator is extended rapidly. Extension of piston 52 when an aiding load is present results in high pressure hydraulic fluid in chamber C₂. High pressure fluid exits chamber C₂ and is directed by direction control valve 62 as well as open pressure control valve 60 to the high pressure (Pₕ) accumulator 34a, FIG. 3. Thus, high pressure hydraulic fluid is regenerated and stored for future reuse.

FIG. 5F shows a high pressure retraction regeneration mode. A high force pushing on piston rod 53 causes piston 52 to move to the left. Low pressure hydraulic fluid Pᵣ is directed by valve 62 to chamber C₂. Low pressure hydraulic fluid Pᵣ may also pass through anti-cavitation check valve 64b to chamber C₂. High pressure fluid in chamber C₁ is directed by direction control valve 62 as well as open pressure control valve 60 to accumulator 34a, FIG. 3.

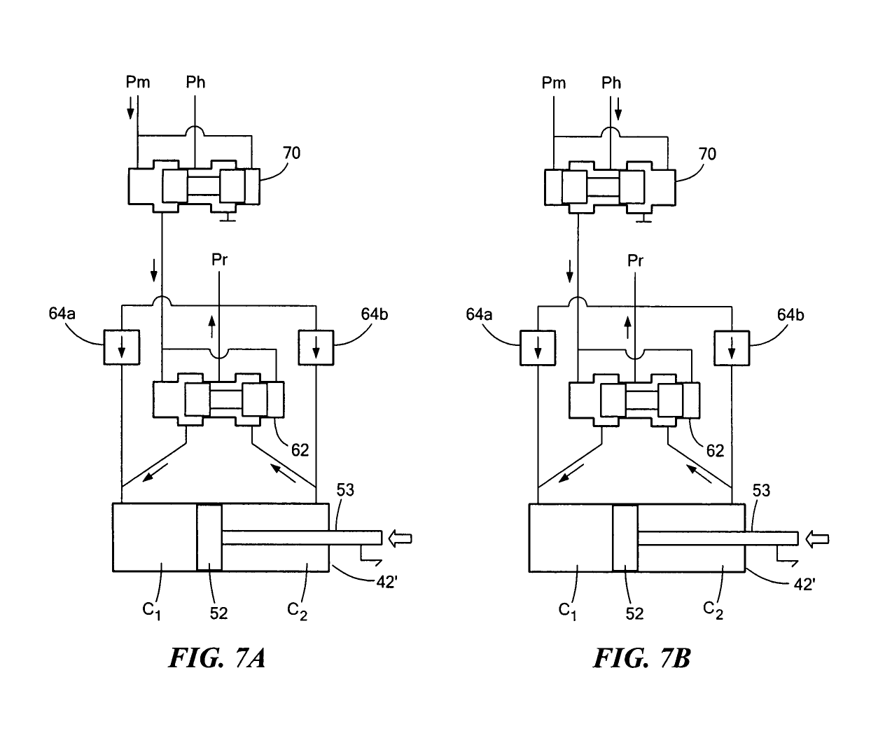

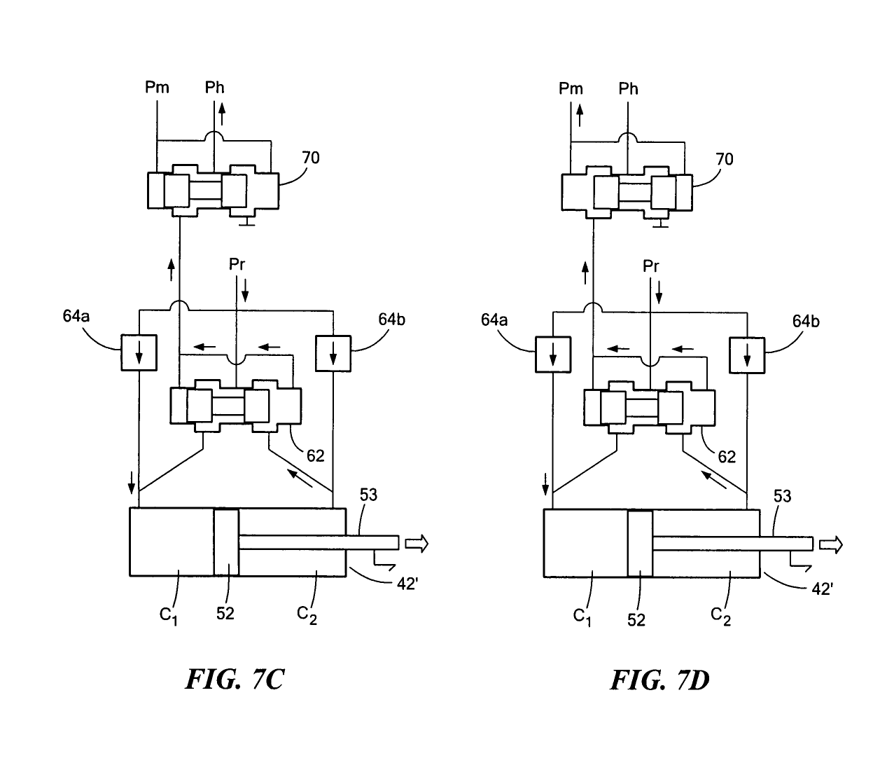

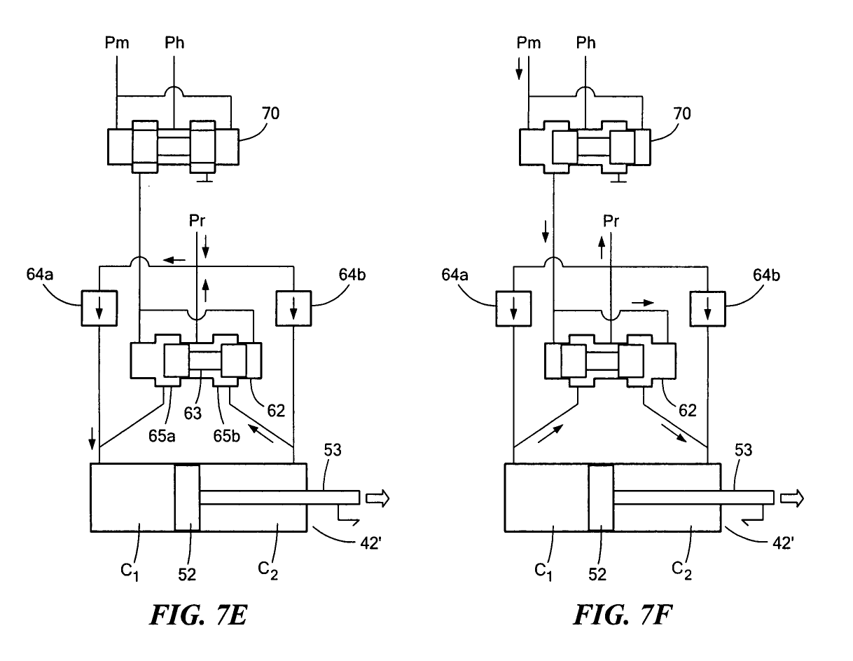

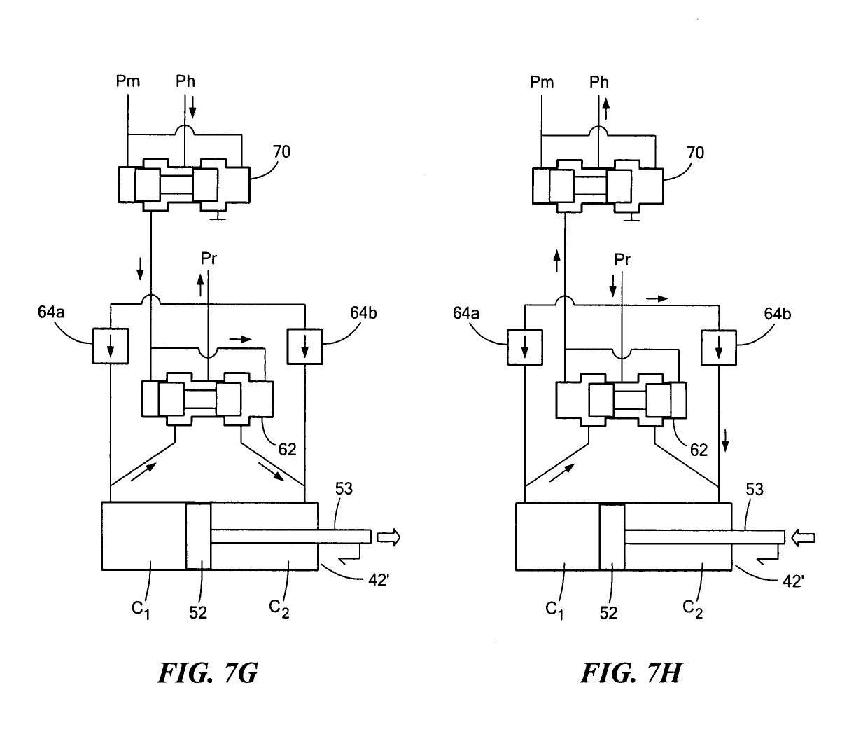

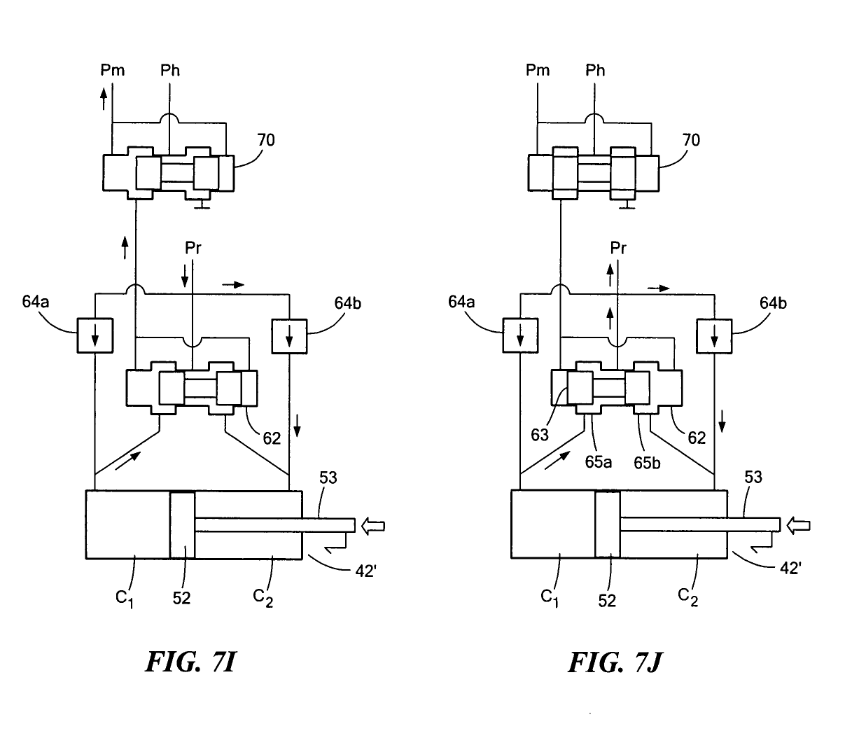

FIG. 6 shows an example of another valve subsystem including pressure control valve 70 and direction control valve 62 controlling the actuation of actuator 42′. In this example, pressure control valve 70 is a three-way valve configured to select the appropriate pressure source Pₘ, Pₕ, or Pᵣ (by nulling the valve). When the pressure control valve is set to null (ports blocked), the chamber C₂ draws from return (Pᵣ) through one of the two check valves 64a and 64b. Direction control valve 62 controls which of chambers C₁ and C₂ communicates with Pᵣ, and which communicates with the supply selected by the pressure control valve. Typically, valve 62 also controls the flow rate. With this valve subsystem, medium pressure extension of piston 52 is possible, as are high pressure extension, extension regeneration to the high pressure source, extension regeneration to the medium pressure source, extension braking, medium pressure retraction, high pressure retraction, retraction regeneration to the high pressure source, retraction regeneration to the medium pressure source, and retraction braking. These modes are depicted in FIG. 7A-7J.

FIG. 7A shows double acting actuator 42′ in connection with direction control valve 62 and pressure control valve 70 in medium pressure extension mode. Pressure control valve 70 is configured in this example to direct medium pressure hydraulic fluid Pₘ from accumulator 34b, FIG. 3, to direction control valve 62, FIG. 7A, which is configured in this mode to direct Pₘ fluid into chamber C₁ to drive piston 52 and extend piston rod 53 with medium force. Lower pressure hydraulic fluid exiting chamber C₂ is directed by direction control valve 62 to the low pressure (Pᵣ) fluid source 38, FIG. 3.

As depicted in FIG. 7B, a high pressure extension mode is shown in which pressure control valve 70 directs high pressure hydraulic fluid Pₕ from accumulator 34a, FIG. 3 to direction control valve 62, FIG. 7B which directs Pₕ fluid into chamber C₁. Pₕ fluid in chamber C₁ drives extension of the piston 52 using high force. Lower pressure hydraulic fluid exiting chamber C₂ is directed by direction control valve 62 to the low pressure (Pᵣ) fluid source 38, FIG. 3.

In extension regeneration to the high pressure source mode, depicted in FIG. 7C, low pressure return hydraulic fluid Pᵣ passes through anti-cavitation check valve 64a and enters chamber C₁. As piston 52 extends under an aiding load, high pressure hydraulic fluid in chamber C₂ is directed by direction control valve 62 to pressure control valve 70 configured in this mode to direct Pₕ fluid to accumulator 34a, FIG. 3.

FIG. 7D shows extension regeneration to the medium pressure source mode in which low pressure return hydraulic fluid Pᵣ from fluid source 38, FIG. 3, passes through anti-cavitation check valve 64a, FIG. 7D, before entering chamber C₁. As piston 52 extends when an aiding load is present, medium pressure hydraulic fluid forms in chamber C₂ and passes through direction control valve 62 and pressure control valve 70 to the medium pressure (Pₘ) accumulator 34b.

FIG. 7E depicts the extension braking mode in which low pressure return hydraulic fluid Pᵣ from fluid source 38, FIG. 3, passes through anti-cavitation check valve 64a, FIG. 7E, before entering chamber C₁. Higher pressure fluid is forced out of chamber C₂ and is directed to pass through direction control valve 62 and back to the Pᵣ source. In this mode, pressure control valve 70 is in the null position. If the direction control valve 62 is wide open (spool 63 to the right), there is little resistance to motion and the actuator is, in effect “coasting”. If the spool is moved to only partially open port 65b, then the actuator will act like a brake.

In FIG. 7F the medium pressure retraction mode is depicted in which pressure control valve 70 is configured to direct medium pressure hydraulic fluid Pₘ from accumulator 34b, FIG. 3, to pass through and enter direction control valve 62, FIG. 7F, which is configured to direct the fluid to pass through and enter chamber C₂. Piston 52 retracts and fluid in chamber C₁ is directed through direction control valve 62 to the low pressure source Pᵣ.

FIG. 7G depicts a high pressure retraction mode in which pressure control valve 70 directs high pressure hydraulic fluid Pₕ from accumulator 34a, FIG. 3, to direction control valve 62, FIG. 7G which is configured to direct this fluid to chamber C₂. Piston 52 retracts, and fluid, present in chamber C₁, is directed by direction control valve 62 to the low pressure fluid source 38, FIG. 3.

FIG. 7H shows a retract regeneration to the high pressure source mode. In this mode, low pressure return fluid Pᵣ from fluid source 38, FIG. 3, passes through anti-cavitation check valve 64b, FIG. 7H, before entering chamber C₂. Piston 52 retracts when a high force aiding load is present, causing pressure to build up in chamber C₁. The resultant high pressure fluid is directed by direction control valve 62 to pressure control valve 70, configured to direct Pₕ fluid into accumulator 34a, FIG. 3.

FIG. 7I depicts the retract regeneration to the medium pressure source mode, in which low pressure return fluid Pᵣ from fluid source 38, FIG. 3, passes through anti-cavitation check valve 64b before entering chamber C₂. Piston 52 retracts when a medium force aiding load is applied, causing pressure to build up in chamber C₁. The resulting medium pressure fluid is directed through direction control valve 62 and into pressure control valve 70, configured to direct Pₘ fluid to accumulator 34b, FIG. 3. In a retraction braking mode, depicted in FIG. 7J, low pressure return hydraulic fluid Pᵣ from fluid source 38, FIG. 3, passes through anti-cavitation check valve 64b, FIG. 7J, before entering chamber C₂. Under an aiding load, piston 52 retracts, pushing fluid out of chamber C₁ back to the low pressure return 38, FIG. 3 as directed by the direction control valve 62. If the direction control valve 62 is wide open (spool 63 to the left), there is little resistance to motion and the actuator is, in effect “coasting”. If the spool is moved to only partially open port 65a, then the actuator will act like a brake.

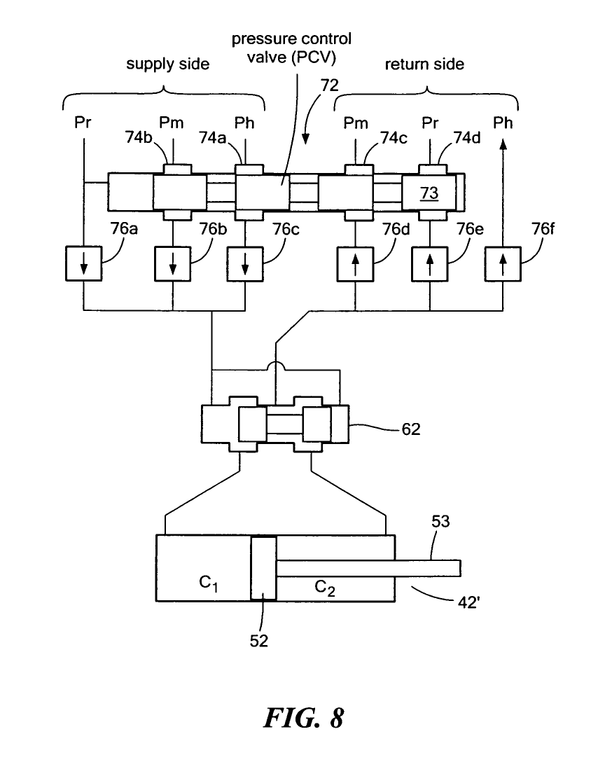

In FIG. 8, pressure control valve 72 includes a supply side with high pressure hydraulic fluid Pₕ and medium pressure hydraulic fluid Pₘ, via ports 74a and 74b, respectively, and a return side with medium pressure port 74c and low pressure return hydraulic fluid port 74d. Check valves 76a, 76b, 76c, 76d, 76e, and 76f are also provided. This valve subsystem uses a pressure control valve configured to select both the supply and return side pressures. Pressure control valve 72 has a moving part (e.g. spool 73) typically driven by a small electric actuator or by pressure applied to a spool extension such as spool extension 67, FIG. 4. Four way directional control valve 62, FIG. 8, is used to control the direction of actuator 42′. Actuator velocity is typically controlled by throttling flow at pressure control valve 72. Throttling flow at the directional control valve is less reliable since it may cause cavitation in the braking and regeneration modes. This valve subsystem allows low pressure extension of piston 52, high pressure extension, extension regeneration to the high pressure source, extension regeneration to the medium pressure source, extension braking, medium pressure retraction, high pressure retraction, retraction braking, retraction regeneration to the high pressure source, and retraction regeneration to the medium pressure source.

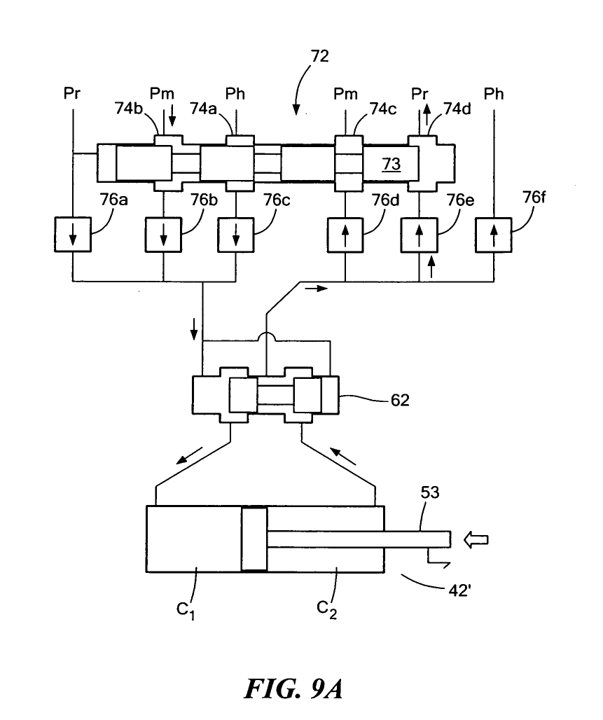

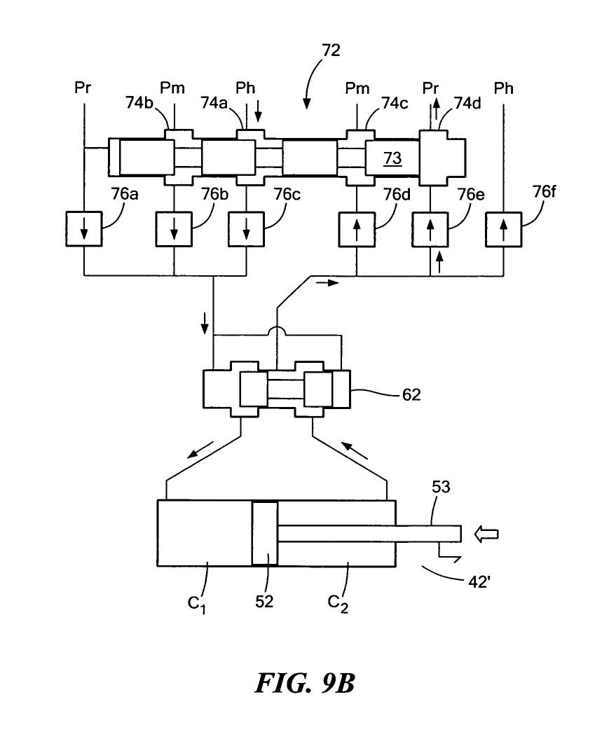

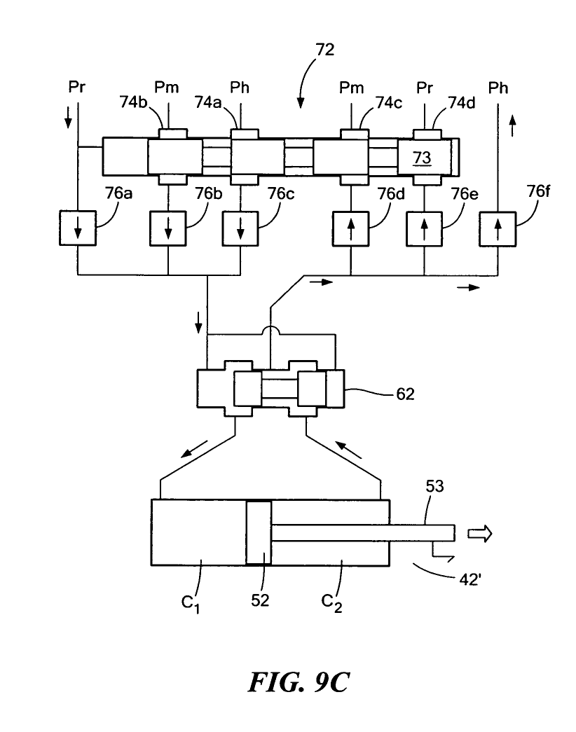

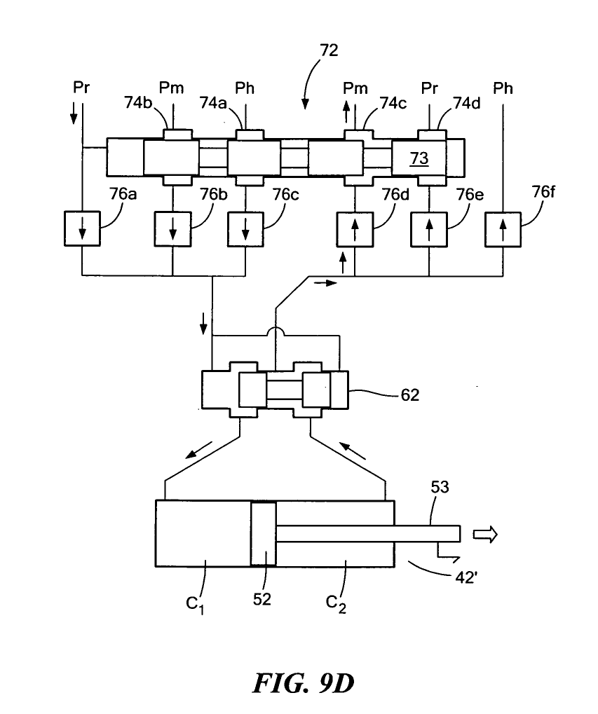

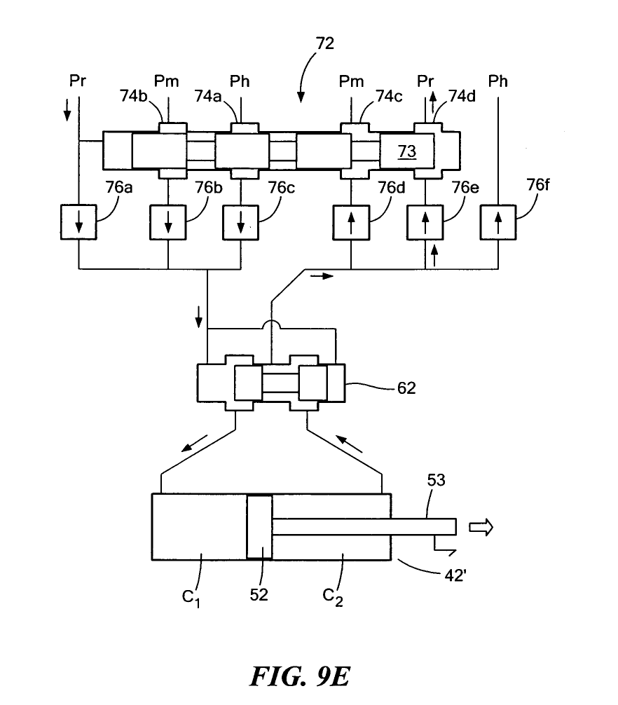

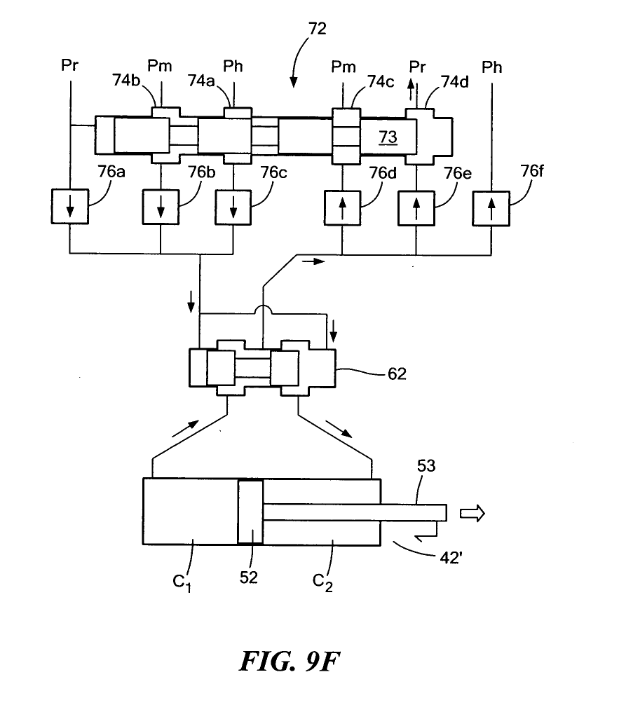

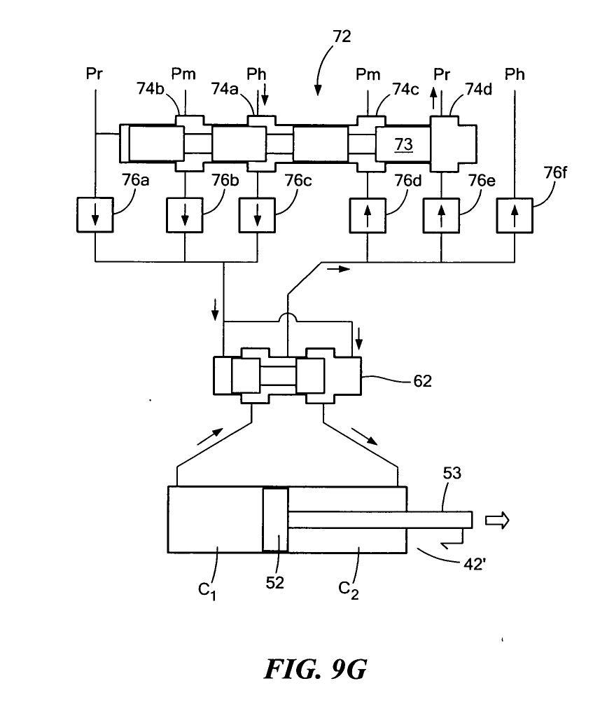

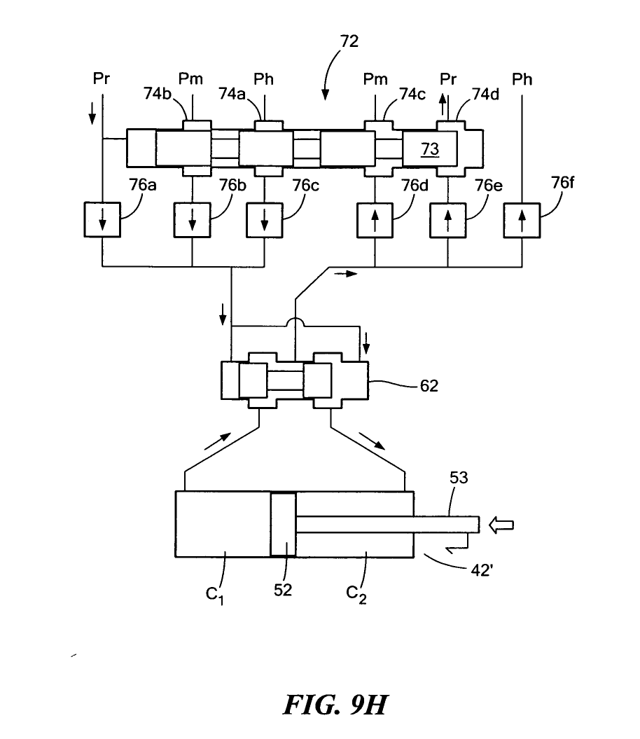

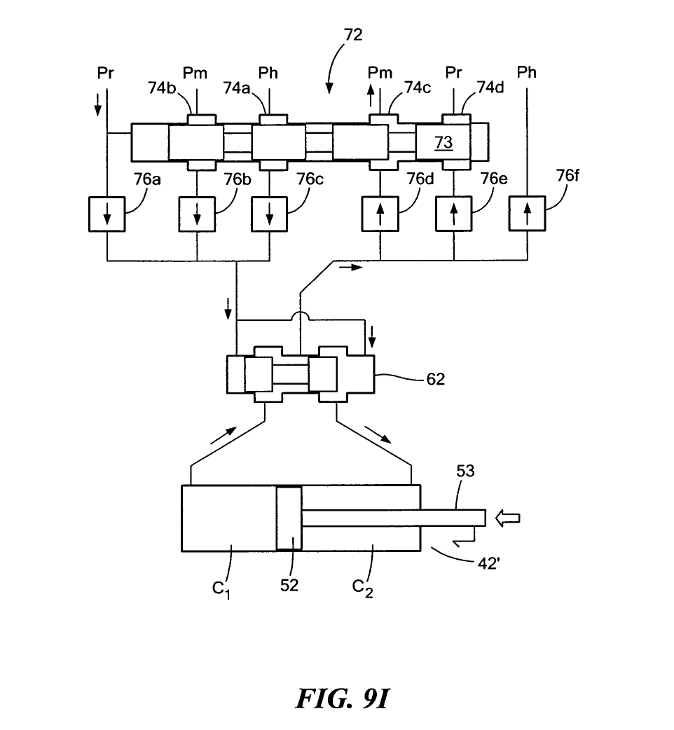

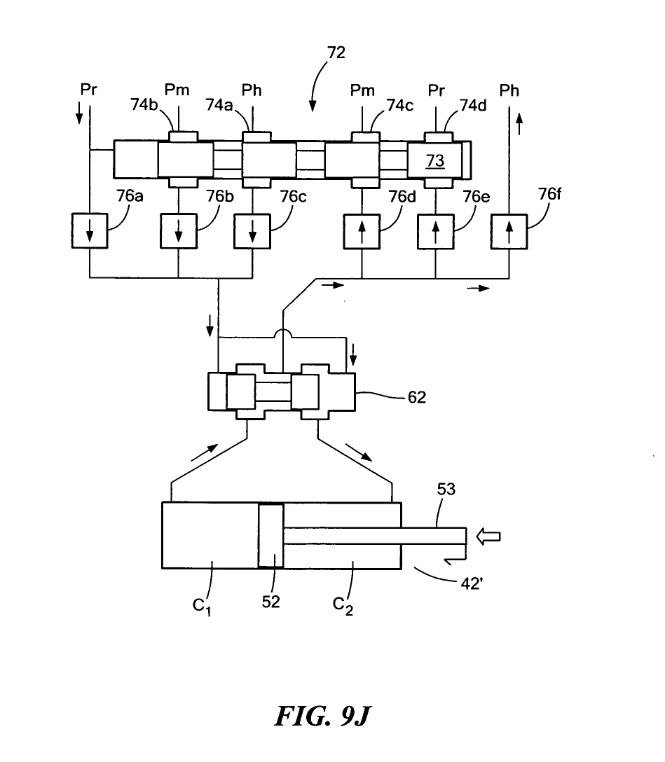

In FIG. 9A, a medium pressure extension mode is shown whereby pressure control valve 72 directs medium pressure hydraulic fluid Pₘ from accumulator 34b, FIG. 3, through via port 74b, FIG. 9A, and check valve 76b to direction control valve 62, which is configured to direct Pₘ fluid to chamber C₁, causing piston 52 to extend with medium force. Return fluid leaves chamber C₂ and is directed by direction control valve 62, to check valve 76e on its way through pressure control valve 72 via port 74d into the Pᵣ fluid source 38, FIG. 3, for future use.

As depicted in FIG. 9B, a high pressure extension mode is shown whereby pressure control valve 72 now is positioned to direct high pressure hydraulic fluid Pₕ from accumulator 34a, FIG. 3, via port 74a, FIG. 9B and check valve 76c to direction control valve 62 which is configured to direct Pₕ fluid into chamber C₁ causing piston 52 to extend with higher force. Return fluid leaves chamber C₂ and is directed by direction control valve 62 to check valve 76e, and then via pressure control valve 72 and port 74d to the Pᵣ fluid source 38, FIG. 3.

FIG. 9C depicts an extension regeneration to the high pressure source mode whereby low pressure return fluid Pᵣ from fluid source 38, FIG. 3, passes through check valve 76a, FIG. 9C, before being directed by direction control valve 62 to enter chamber C₁. High pressure hydraulic fluid is generated in chamber C₂ and is directed by direction control valve 62 and pressure control valve 72 through check valve 76f to the high pressure accumulator 34a, FIG. 3 for future use.

In FIG. 9D, an extension regeneration to the medium pressure source mode is depicted whereby low pressure return fluid Pᵣ from fluid source 38, FIG. 3, passes through check valve 76a, FIG. 9D, before being directed by direction control valve 62 into chamber C₁. Medium pressure hydraulic fluid is now generated in chamber C₂ and is directed by direction control valve 62 to check valve 76d and by valve 72 via port 74c to the Pₘ accumulator 34b, FIG. 3, for future use.

In an extension braking mode, depicted in FIG. 9E, low pressure return fluid Pᵣ from fluid source 38, FIG. 3, passes through check valve 76a, FIG. 9E, before being directed by direction control valve 62 to chamber C₁. Return fluid exits chamber C₂ and is directed by direction control valve 62 to check valve 76e before being directed by pressure control valve 72 to the Pᵣ return line via port 74d as shown.

FIG. 9F depicts a medium pressure retraction mode whereby medium pressure hydraulic fluid Pₘ from accumulator 34b, FIG. 3, is directed by pressure control valve 72, FIG. 9F via port 74b into check valve 76b and then directed by direction control valve 62 into chamber C₂ causing piston 52 to retract with medium force. Return fluid exits chamber C₁ and is directed by direction control valve 62 to check valve 76e and then directed to the Pᵣ return line by pressure control valve 72 via port 74d as shown.

As depicted in FIG. 9G, a high pressure retraction mode is shown whereby high pressure hydraulic fluid Pₕ from accumulator 34a, FIG. 3 is directed by pressure control valve 72, FIG. 9G, via port 74a to check valve 76c and then directed by direction control valve 62 to chamber C₂ causing piston 52 to retract with high force.

In a retraction braking mode as depicted in FIG. 9H, low pressure return fluid Pᵣ from fluid source 38, FIG. 3, passes through check valve 76a, FIG. 9H, before being directed by direction control valve 62 to chamber C₂. Fluid also exits chamber C₁ and is directed by direction control valve 62 into check valve 76e before being directed by pressure control valve 72 via port 74d to the Pᵣ fluid source 38, FIG. 3.

FIG. 9I depicts a retraction regeneration to the medium pressure source mode whereby low pressure return fluid Pᵣ from fluid source 38, FIG. 3, passes through check valve 76a, FIG. 9A and is directed by direction control valve 62 into chamber C₂. An aiding load applied to piston rod 53 retracts it and generates medium pressure hydraulic fluid in chamber C₁ which is directed by direction control valve 62 to check valve 76d before being directed by pressure control valve 72 via port 74c to the Pₘ accumulator 34b, FIG. 3 for future use.

As depicted by FIG. 9J, in a retraction regeneration to the high pressure source mode, high pressure hydraulic fluid is generated in chamber C₁ and is directed by direction control valve 62 and pressure control valve 72 through check valve 76f to the Pₕ accumulator 34a, FIG. 3.

In the embodiment of FIGS. 8 and 9A-9J, control of actuator speed is best achieved by moving the spool 73 of pressure control valve 72 so as to partially close the return side flow through ports 74c or 74d. Use of the directional control valve 62 to control flowrate is also possible, but can result in cavitation if the actuator is subject to a high-speed aiding load.

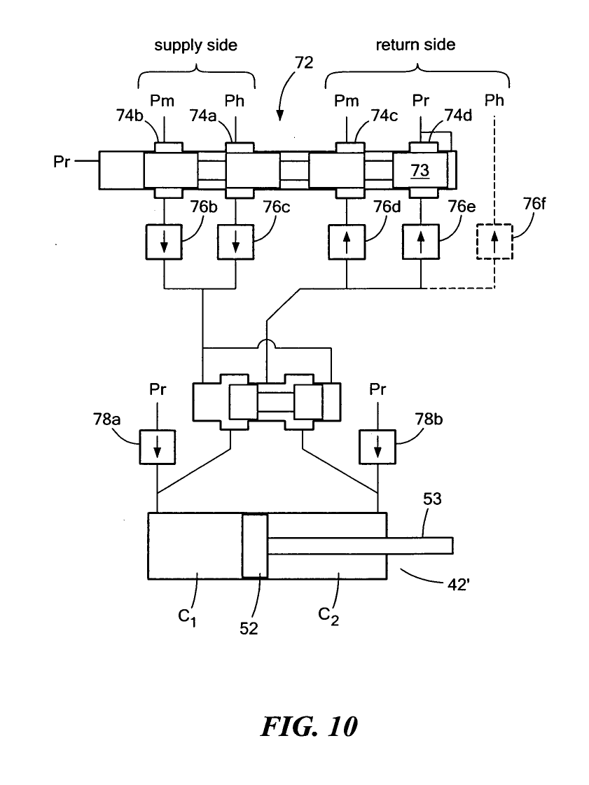

FIG. 10 shows a variation on the embodiment of FIGS. 8, 9A-9J in which the check valve 76a, FIG. 9A, is replaced by two anti-cavitation check valves 78a and 78b, FIG. 10 each connecting between the low pressure source Pᵣ and chambers C₁ and C₂ respectively. These valves prevent cavitation when there is a high-speed aiding load. In this variation, flowrate can be reliably controlled by the direction control valve 62 and/or by the pressure control valve 72. This variation also shows check valve 76f with dashed lines to indicate that this valve is optional. It is needed only to allow the two “regeneration to the high pressure source” modes shown in FIGS. 91 and 9J. For many applications, such as lifting and lowering a load, the load being lowered is generally not greater than the maximum load that can be raised, therefore regeneration to the high pressure source is rare and check valve 76f may be unnecessary. It should be mentioned that this variation, i.e. FIG. 10 without check valve 76f, still has the same force capability as when check valve 76f is present since either or both of the two control valves 62 and 72 can resist the flow of fluid leaving C₁ or C₂, but without check valve 76f, the circuit is regenerative only to the medium pressure Pₘ, and is therefore less energy efficient when there is a high-force aiding load.

One advantage of the embodiments of FIG. 8, 9A-9J, and 10, is that the pressure control valve 62 can change the operational mode without momentary interruption of the flowrate (known as “dead-heading”). This is especially important when actuator 42′ is coupled to a large, high-speed inertial load. Another advantage is that spool 73 of valve 72 is configured to open the ports in sequence 74c, 74d, 74b, 74a, to progressively lower the pressure on the return side from Pₕ to Pᵣ (with Pr selected to supply flow) and then progressively increase the pressure on the supply side from Pₘ to Pₕ (while selecting Pᵣ on the return side). This arrangement allows smooth control of actuator force and does not require large or abrupt changes in spool position.

FIG. 11 shows how a variety of modes are possible in different designs of the valve subsystem in accordance with examples of the invention. All ten modes are possible with the design shown in FIGS. 8 and 9A-9J, and the variation of FIG. 10 including check valve 76f. Neglecting friction, leakage and pressure drops across valves and hoses, a 75% reduction in hydraulic power is theoretically possible, e.g. for an actuator repeatedly compressing and extending a linear spring, as compared with a conventional servo-actuator circuit.

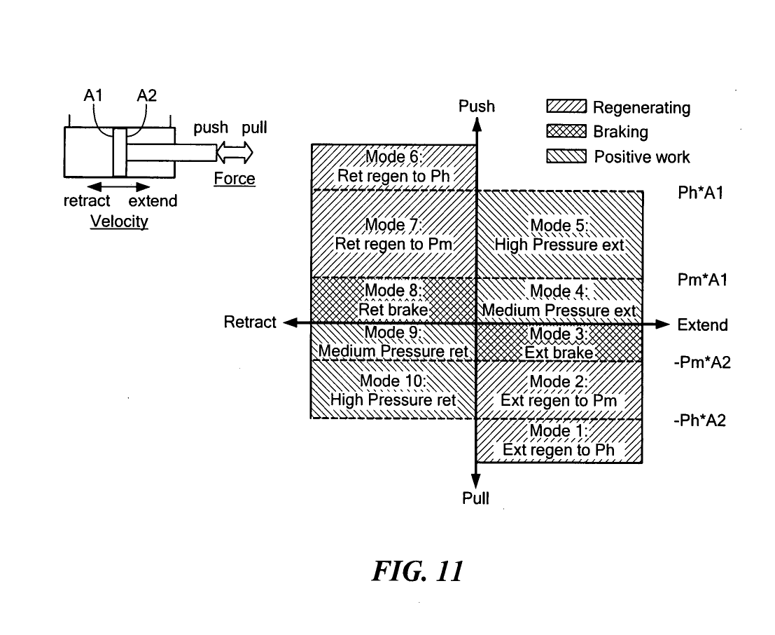

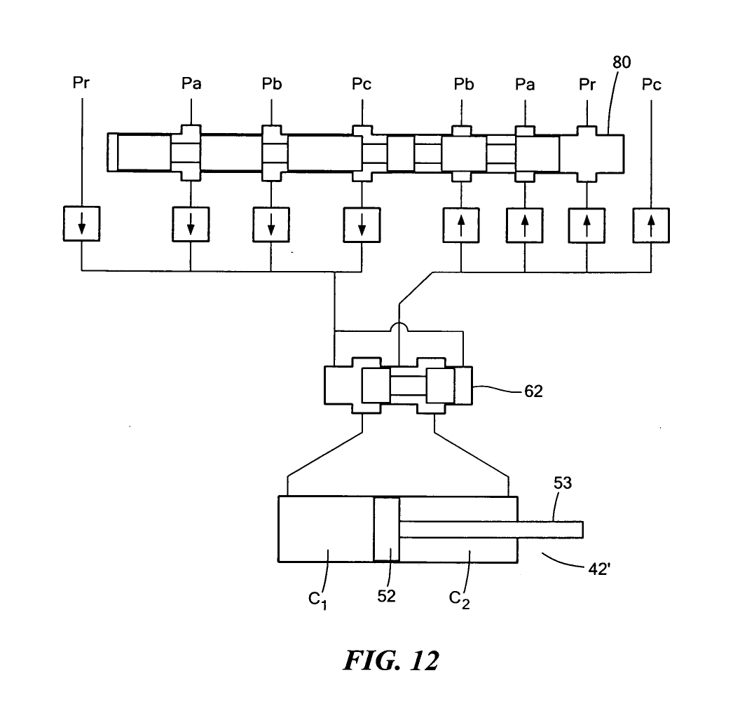

FIG. 12 shows a pressure control valve 80 which allows extension of the concept of the subject invention to any number of supply pressures, for example, and Pₐ, P_{b}, P_{c}, return (Pᵣ), where Pₐ>P_{b}>P_{c}>Pᵣ. Advantageously, more supply pressures has only a minor effect on control complexity. Efficiency is improved due to more levels of regeneration and reduced pressure differentials between the chamber pressure and the supply. Accordingly, in this example, piston rod 53 can be driven to extend or retract using the highest pressure source available, an intermediate pressure source, or a lower pressure source.

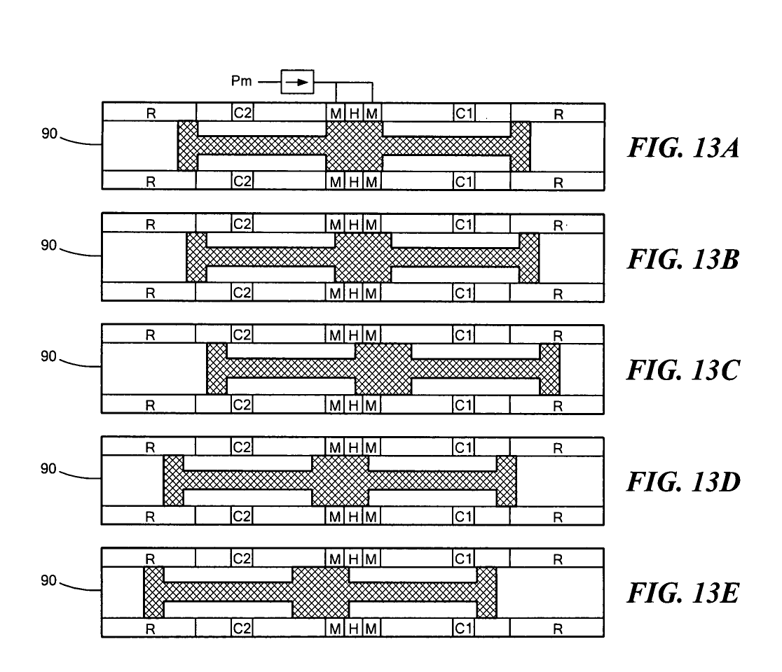

FIGS. 13A-13E show an example where the valve subsystem includes a dual pressure spool valve 90 configured to select which of the high pressure hydraulic fluid and the medium pressure hydraulic fluid is delivered to the actuator and also to select the direction of actuation of the actuator. The ports of the spool valve are preferably arranged such that movement of the spool in direction away from the null position first draws from the medium pressure source Pₘ (marked “M”), and then draws from the high pressure source Pₕ (marked “H”). Movement of the spool in the opposite direction switches which actuator chamber receives the supply pressure. The return flow is always directed to Pᵣ (marked “R”), and the device is not capable of braking, nor regeneration to medium pressure. FIG. 13A shows the null position where all ports are blocked. The four main operational modes are shown in FIGS. 13B-13E. FIG. 13B shows the medium pressure retraction mode for the piston where chamber C₁ is connected to the return hydraulic pressure and chamber C₂ is connected to the medium pressure source. FIG. 13C shows a high pressure retraction mode where chamber C₁ is connected to the return hydraulic pressure source and chamber C₂ is connected to the high pressure fluid supply. FIG. 13D shows medium pressure extension mode where chamber C₂ is connected to the return hydraulic fluid and chamber C₁ is connected to the medium pressure hydraulic fluid source. FIG. 13E shows high pressure extension where chamber C₂ is connected to the return and chamber C₁ is connected to the high pressure hydraulic fluid. Under a sufficiently high force aiding load, the valve positions shown in FIGS. 13C and 13E can also be used to regenerate fluid back to the high pressure accumulator FIG. 3, 34a.

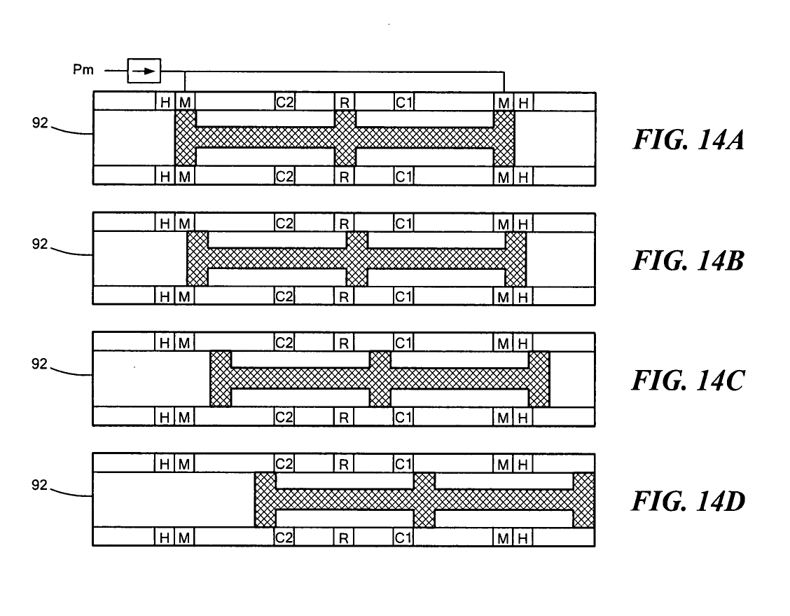

FIGS. 14A-14D show another spool valve variation 92 which controls both pressure and direction with a single valve. This variation includes a braking mode. Several of these modes are illustrated including a null position (FIG. 14A), medium pressure extension as shown in FIG. 14B (chamber C₂ connected to return, chamber C₁ connected to Pₘ), high pressure extension as shown in FIG. 14C (C₂ connected to return and C₁ connected to Pₕ), and a coast/braking mode as shown in FIG. 14D where both C_{1 and C}₂ are connected to return. Movement of the spool away from null in the opposite direction provides the above three modes in retraction instead of extension. The valve position of FIG. 14C and its minor image provide two additional modes: retraction regeneration to high pressure and extension regeneration to high pressure respectively. A downside of this example 92 is that it cuts off flow momentarily as the spool goes from one of the driving modes (i.e. medium or high pressure extension or retraction) to one of the braking modes. For this reason, the valve is best used to drive low-inertia loads at low speeds and/or where the spool can be repositioned very quickly.

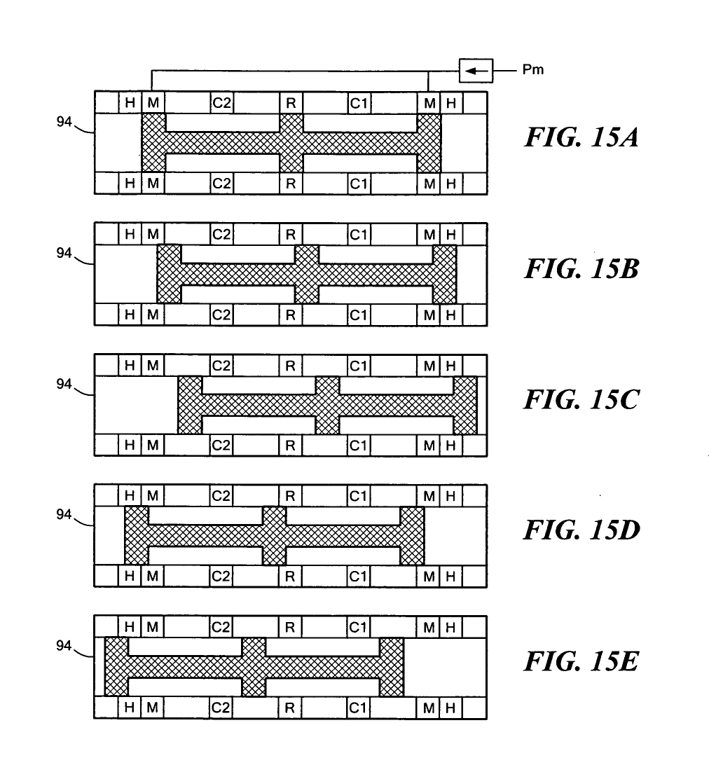

FIGS. 15A-15E depict yet another spool valve concept 94 capable of controlling actuator force and direction using pressure sources Pᵣ, Pₘ and Pₕ. This variation is functionally similar to that shown in FIGS. 13A-13E, but is more compact. FIG. 15A shows concept 94 in the null position with all ports blocked. FIG. 15B shows medium pressure extension mode, FIG. 15C shows high pressure extension, FIG. 15D shows medium pressure retraction, and 15E shows high pressure retraction. The high pressure modes can also be regenerative given a sufficiently large aiding load. Theoretical power savings, doing positive and negative work against a spring, is 37.5% for this and for the concept of FIGS. 13A-13E. The concept depicted in FIGS. 14A-14D has a higher theoretical savings (50%) because of the coast/brake mode.

An energy saving is thus effected in a method in accordance with the invention, for example, as shown for actuator 20, FIG. 2, by producing high pressure hydraulic fluid, producing medium pressure hydraulic fluid, establishing high pressure criteria for actuator 20, and establishing medium pressure criteria for actuator 20. In response to high pressure criteria, actuator 20 is driven using the high pressure fluid. In response to medium pressure criteria, actuator 20 is driven using medium pressure fluid. Low pressure hydraulic fluid (e.g., return fluid) is valved to and from the actuator as appropriate. Numerous modes may be possible depending on the valving subsystem including regeneration of high pressure hydraulic fluid during actuation of actuator 20 in one direction, regeneration of medium pressure hydraulic fluid during actuation of the actuator in that direction, braking of the actuator, medium pressure actuation of the actuator, and high pressure actuation of the actuator. The same is true in respect to the other direction of actuation of actuator 20 (regeneration of high pressure hydraulic fluid, regeneration of medium pressure hydraulic fluid, braking, medium pressure actuation, and high pressure actuation). Actuators exist that rotate in different directions as opposed to extending and retracting. Examples of rotary hydraulic devices include rotary-vane actuators and hydraulic gearmotors. Also, the invention can be applied to single acting actuators.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A hydraulic circuit comprising:
a high pressure source of high pressure hydraulic fluid;
a medium pressure source of medium pressure hydraulic fluid;
a low pressure return for low pressure hydraulic fluid;
an actuator;
a valve subsystem between the high pressure source, the medium pressure source, the low pressure return, and the actuator, and controllable to drive the actuator using the high pressure hydraulic fluid or the medium pressure hydraulic fluid and to direct low pressure hydraulic fluid exiting the actuator to the low pressure return; and
a controller responsive to high pressure criteria and medium pressure criteria associated with the actuator and configured to switch the valve subsystem to present high pressure hydraulic fluid to the actuator in response to high pressure criteria and to present medium pressure hydraulic fluid to the actuator in response to medium pressure criteria.

2. The circuit of claim 1 in which the actuator is a double acting actuator.

3. The circuit of claim 2 in which the valve subsystem includes a pressure control valve configured to select which of the high pressure hydraulic fluid and the medium pressure hydraulic fluid is delivered to the actuator.

4. The circuit of claim 3 in which the valve subsystem further includes a direction control valve configured to select the direction of action of the actuator.

5. The circuit of claim 4 in which the pressure control valve is switchable to direct high or medium pressure hydraulic fluid to the direction control valve.

6. The circuit of claim 4 in which the direction control valve is a four-way direction control valve.

7. The circuit of claim 4 in which the pressure control valve includes means for controlling the flow rate of the hydraulic fluid delivered to the actuator.

8. The circuit of claim 1 in which the valve subsystem is further configured to valve low pressure return hydraulic fluid to the actuator.

9. The circuit of claim 1 in which the valve subsystem is further configured to selectively valve high pressure hydraulic fluid produced by the actuator to the high pressure source.

10. The circuit of claim 1 in which the valve subsystem is further configured to selectively valve medium pressure hydraulic fluid produced by the actuator to the medium pressure hydraulic fluid source.

11. The circuit of claim 10 in which the valve subsystem includes a pressure control valve with a supply side including high pressure hydraulic fluid and medium pressure hydraulic fluid ports and a return side including medium pressure hydraulic fluid and low pressure return hydraulic fluid ports.

12. The circuit of claim 1 in which the valve subsystem is configured to control the flow rate of hydraulic fluid delivered to the actuator.

13. The circuit of claim 1 in which the valve subsystem includes a spool valve configured to both select which of the high pressure hydraulic fluid and the medium pressure hydraulic fluid is delivered to the actuator and to select a direction of action of the actuator.

14. The circuit of claim 1 in which the valve subsystem includes a valve with a spool and ports arranged such that movement of the spool in one direction progresses from providing medium pressure fluid to the actuator and then providing high pressure fluid to the actuator.

15. The circuit of claim 14 in which the spool valve has a return side and a supply side configured such that movement of the spool in one direction provides progressively decreasing pressure fluid on the return side and then provides progressively increasing pressure fluid on the supply side.

16. The circuit of claim 1 in which the high pressure criteria and medium pressure criteria are a function of the force and/or speed to be produced by the actuator.

17. The circuit of claim 1 in which the actuator is a double acting actuator and the valve subsystem is configured to actuate the actuator in a first direction and a second direction and in four or more modes including regeneration of high pressure hydraulic fluid during actuation of the actuator in the first direction, regeneration of medium pressure hydraulic fluid during actuation in the first direction, braking of the actuator during actuation in the first direction, medium pressure actuation of the actuator in the first direction, high pressure actuation of the actuator in the first direction, regeneration of high pressure hydraulic fluid during actuation of the actuator in the second direction, regeneration of medium pressure hydraulic fluid during actuation of the actuator in the second direction, braking of the actuator during actuation in the second direction, medium pressure actuation of the actuator in the second direction, and/or high pressure actuation of the actuator in the second direction.

18. The circuit of claim 1 in which the valve subsystem is configured to prevent interruption of flow to or from the actuator during switching of the selection of the pressure source communicating with the actuator.

19. A method of actuating an actuator comprising:
producing high pressure hydraulic fluid;
producing medium pressure hydraulic fluid;
valving low pressure hydraulic fluid;
establishing high pressure criteria for the actuator;
establishing medium pressure criteria for the actuator;
in response to high pressure criteria, driving the actuator using high pressure hydraulic fluid; and
in response to medium pressure criteria, driving the actuator using medium pressure fluid.

20. The method claim 19 in which the actuator is a double acting actuator configured to actuate in a first direction and a second direction and the method includes actuating the actuator in four or more modes including regeneration of high pressure hydraulic fluid during actuation of the actuator in the first direction, regeneration of medium pressure hydraulic fluid during actuation in the first direction, braking of the actuator during actuation in the first direction, medium pressure actuation of the actuator. in the first direction, high pressure actuation of the actuator in the first direction, regeneration of high pressure hydraulic fluid during actuation of the actuator in the second direction, regeneration of medium pressure hydraulic fluid during actuation of the actuator, braking of the actuator during actuation in the second direction, medium pressure actuation of the actuator in the second direction, and/or high pressure actuation of the actuator in the second direction.

21. The method of claim 20 in which there are at least six said modes.

22. The method of claim 19 including selecting which of the high pressure hydraulic fluid and the medium pressure hydraulic fluid is delivered to the actuator and selecting the direction of the actuator.

23. The method of claim 19 including controlling the flow rate of the hydraulic fluid delivered to the actuator.

24. The method of claim 19 including valving low pressure hydraulic fluid to the actuator.

25. The method of claim 19 including storing and re-using high pressure hydraulic fluid produced by the actuator.

26. The method of claim 19 including storing and re-using medium pressure hydraulic fluid produced by the actuator.

27. The method of claim 19 in which the actuator includes first and second chambers and the method includes selectively valving high pressure hydraulic fluid to each chamber, medium pressure hydraulic fluid to each chamber, and low pressure hydraulic fluid from each chamber.

28. The method of claim 27 further including selectively valving high pressure hydraulic fluid from each chamber, medium pressure hydraulic fluid from each chamber, and low pressure hydraulic fluid to each chamber.
